(19) United States
(12) Patent Application Publication
(10) Pub. No.: US 2009/0324888 A1
(43) Pub. Date: Dec. 31, 2009

(54) PROCESS FOR PRINTING ON CLEATED SURFACES

(76) Inventor: Edward S. Robbins, III, Muscle Shoals, AL (US)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/475,798

(22) Filed: Jun. 1, 2009

Related U.S. Application Data
(60) Provisional application No. 61/075,612, filed on Jun. 25, 2008.

(51) Int. Cl. B32B 3/26; B32B 3/10; B41J 25/308

(52) U.S. Cl. 428/156; 347/8

(57) ABSTRACT

A printing process to be applied to the whole or any selected portion of the lower surface of a mat having carpet-engaging features substantially equally distributed over the whole of the lower surface. The application of a desired graphic pattern using a computer controlled ink jet that is spaced from the lower surface of the mat by a distance exceeding the height of the carpet-engaging features. The space between the computer controlled ink jet and the carpet engaging features is preferable sufficient to ensure that the carpet engaging features will have substantially all surfaces subjected to the ink delivered by the ink jet including the lower surface of the mat, and the lower and lateral surfaces of the carpet-engaging features. The ink can be reactive to radiation such as ultra-violet light to bond the ink to the mat lower surface and carpet-engaging features. At least the selected area of the mat lower surface can be pre-treated by plasma or another oxidizing medium to enhance the acceptance of the ink jet spray.

### CROSS-REFERENCE TO RELATED APPLICATION

This application is related to, and claims all available benefit of, U.S. provisional application Ser. No. 61/075,612 filed Jun. 25, 2008.

### BACKGROUND OF THE INVENTION

The present invention relates generally to the application of decorative elements to the surface of articles having significant projections from the relevant surfaces. The present invention relates particularly to the application of decorative elements to an under surface of a mat such as a carpet runner, floor mat or desk chair mat having a continuous pattern of downward projections intended to engage an underlying carpet or floor.

Mats such as desk chair mats for office and home use are well known. A desk chair mat can have a main portion on which the desk chair rolls, and can include a forward lip portion adapted to extend partially into a desk well, and on which the feet of the person sitting in the chair can rest. A typical chair mat tends to be positioned over carpeting. A desk chair mat that is to be applied over carpeting is typically formed of a semi-rigid plastic, and has an array of short, sharp spikes on an underside thereof, which hold the mat firmly in place on the carpeting. The sharp spikes can be replaced or interspersed by blunt projections as disclosed in my U.S. Pat. No. 6,946,184. While desk chair mats can be made without any projections, such mats tend to move relative to the carpet in response to movement of any desk chair on the top surface of the mat. Thus a carpet-engaging structure is deemed necessary to achieve satisfactory performance on carpet.

Mats can be made of a transparent or translucent plastic material. Thus, the underlying carpet on which the mat is placed is visible through the mat as are the structural details of the pattern of projections that project down to engage the carpet. The mat generally does not make any separate esthetic contribution. Some attempts have been made to arrive at mats that contribute esthetically as well as provide protection for the underlying carpet, for example, the mat disclosed in U.S. Pat. No. 6,319,592 to Ney et al. The Ney mat consists of a separately prepared graphics layer sandwiched between a rigid base layer and a rigid upper protective layer. Both the base layer and upper protective layer were bonded to the graphics layer with the aid of adhesives. The nature of the graphics layer or the underlying adhesives layer is such as to render the base layer invisible. The area of the carpeting under such a chair mat would also be rendered invisible. This has the effect of making the chair mat itself stand out from the remaining portion of the carpeting, which may not be desirable in many situations.

In my prior U.S. Pat. No. 7,029,743, I disclosed a chair mat having an array of projections confined to a first selected area of the bottom or lower surface of the mat, while a second selected area of the lower surface including a graphic that is visible through the upper surface of the chair mat. The array of projections in the first area can resist lateral forces acting on the desk chair mat and thereby stabilizes the mat with respect to the carpet sufficiently to prevent any significant wear of the graphic in the second area. The graphic in the second area was disclosed to be created by an embossed or etched graphics pattern on a pattern roll that is brought into intimate contact with the lower surface of the mat. Alternatively, the graphic can also be applied by contacting the second area of the chair mat lower surface with a silk screen mat, a print transfer roll, a label, a decal, or other indicia bearing sheet or transfer roll. That is in all disclosed processes, the graphic was to be developed in the second area on the lower surface of the mat, which is devoid of any projections, by direct contact between the mat and a pattern defining member. In this manner, the first surface can remain un-affected by the application of the graphic so that the chair mat is generally transparent except where the subject matter of the graphic sufficiently inhibits the view of the underlying carpet. Thus the graphic and mat lower surface had to be custom designed in relation to each other so the graphic would fit within the area devoid of the projections.

Despite the various features and benefits of the structures of the forgoing disclosures, there remains a need for a process that will permit a graphic to be applied to a lower surface of the mat while avoiding the necessity of any custom defining the area of the graphic to exclude carpet engaging features from the area. There also remains a need for process that will apply the graphic to the lower surface of a wide variety of mats having carpet-engaging features including desk chair mats, carpet mats, and carpet runners. There also remains a need for a process that will apply the graphic to the lower surface of mats having a wide variety of carpet-engaging features.

### SUMMARY OF THE INVENTION

These several needs can be satisfied by a printing process to be applied to the whole or any selected portion of the lower surface of a mat having carpet-engaging features substantially equally distributed over the whole of the lower surface. The process involves the application of a desired graphic pattern using a computer controlled ink jet that is spaced from the lower surface of the mat by a distance exceeding the height of the carpet-engaging features. The space between the computer controlled ink jet and the carpet engaging features is preferably sufficient to ensure that the carpet engaging features will have substantially all surfaces subjected to the ink delivered by the ink jet. On the other hand, the space between the computer controlled ink jet and the carpet engaging features should be minimized so that the image being printed on the lower surface of the mat will retain the desired image resolution and detail.

The ink jet can be a thermal bubble type printing head or piezoelectric type printing head. The spacing of the ink jet from the mat lower surface can be adjusted either mechanically or electronically. The ink jet can be situated above the mat with the surface having the carpet-engaging features located below the ink jet so that the ink delivered from the ink jet to the mat surface is substantially undisturbed by gravity. The spray pattern from the ink jet can be such that the lower surface of the mat, and the lower and side surfaces of the carpet-engaging features can receive the ink output by the ink jet. The ink is preferably reactive to radiation such as ultra-violet light to bond the ink to the mat lower surface and carpet-engaging features. At least the selected area of the mat lower surface can be pre-treated by plasma or another oxidizing medium to enhance the acceptance of the ink jet spray. At least the selected area of the mat lower surface can be simultaneously printed with an opaque background, for example white, which is aligned with the desired graphic pattern to enhance the color and contrast of the image. This simultaneous background printing eliminates the need for re-registration of the mat relative to the printer, which if incorrectly done results in shadows and pale images.

Other features of the present invention and the corresponding advantages of those features will become apparent from the following discussion of the preferred embodiments of the present invention, exemplifying the best mode of practicing the present invention, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 is a perspective view of a carpet runner with a corner up turned to show the carpet engaging features on a lower surface.

FIG. 2 is a sectional view of the carpet runner of FIG. 1.

FIG. 3 is a perspective view of another carpet runner.

FIG. 4 is a plan view of the carpet runner of FIG. 2.

FIG. 5 is a sectional view taken along line 5-5 of a portion of the carpet runner shown in FIG. 4.

FIG. 6 is another sectional view taken along line 6-6 of a portion of the carpet runner shown in FIG. 4.

FIG. 7 is a perspective view of a carpet mat.

FIG. 8 is a sectional view of the carpet mat shown in FIG. 7.

FIG. 9 is a sectional view of another carpet mat.

FIG. 10 is lower plan view of the carpet mat shown in FIG. 9.

FIG. 11 is a perspective view of yet another carpet mat with an end up turned to show the carpet engaging features on a lower surface.

FIG. 12 is a lower plan view of the carpet mat shown in FIG. 11.

FIG. 13 is a sectional view of the carpet mat shown in FIGS. 11 and 12.

FIG. 14 is a lower plan view of a portion of a desk chair mat.

FIG. 15 is a sectional view of the desk chair mat shown in FIG. 14.

FIG. 16 is a perspective view showing a portion of another desk chair mat.

FIG. 17 is a perspective view of the lower surface of another carpet mat.

FIG. 18 is a partially schematic view of an ink jet printer and work piece including carpet engaging features.

FIG. 19 is another partially schematic view of an ink jet printer and work piece.

FIG. 20 is another partially schematic view of an ink jet printer and work piece.

FIG. 21 is a close-up of a single ink jet from FIG. 20 showing a desirable arrangement for the ink jet in relation to the carpet engaging features.

FIG. 22 is another partially schematic view of an ink jet printer and work piece.

### DESCRIPTION OF PREFERRED EMBODIMENTS

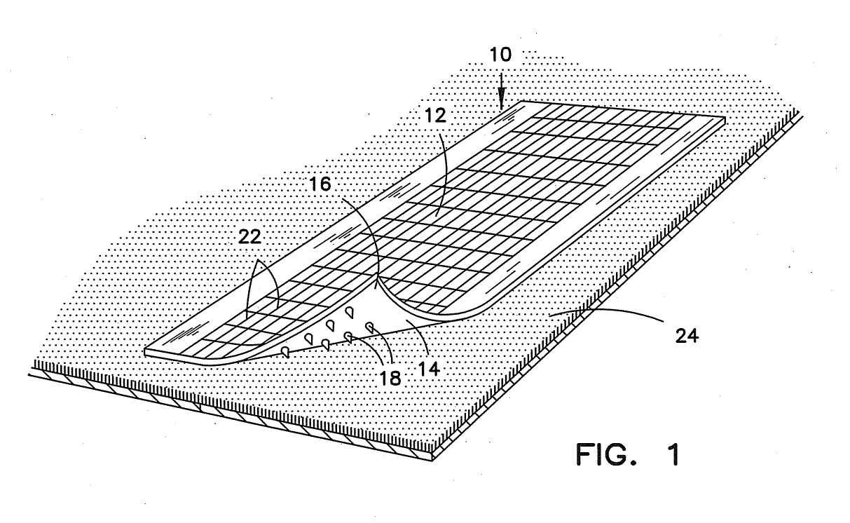

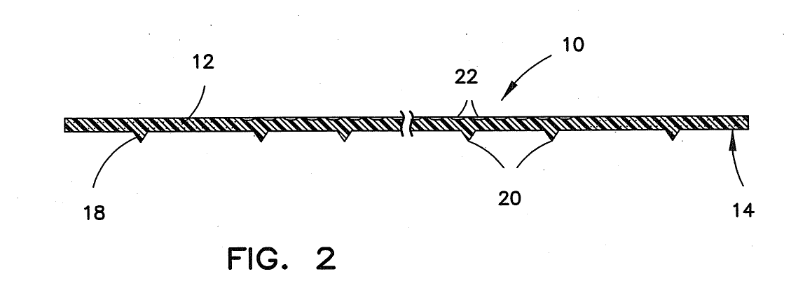

A carpet runner 10 is shown in FIG. 1 having a top surface 12 and a lower surface 14. A corner 16 of the carpet runner 10 is up turned to show the lower surface 14 and the carpet engaging features 18 on the lower surface 14. The carpet engaging features 18 can be simple conical projections 20 as shown in FIGS. 1 and 2. The carpet engaging features 18 can be substantially uniformly distributed across the lower surface 14. The top surface 12 can include additional surface features 22. The carpet runner 10 can be transparent or sufficiently translucent that the underlying carpet 24 can be seen through the carpet runner 10. The carpet runner 10 shown in FIGS. 1 and 2 can be used in a printing process, discussed below, which can be applied to the whole or any selected portion of the lower surface 14 of the carpet runner 10.

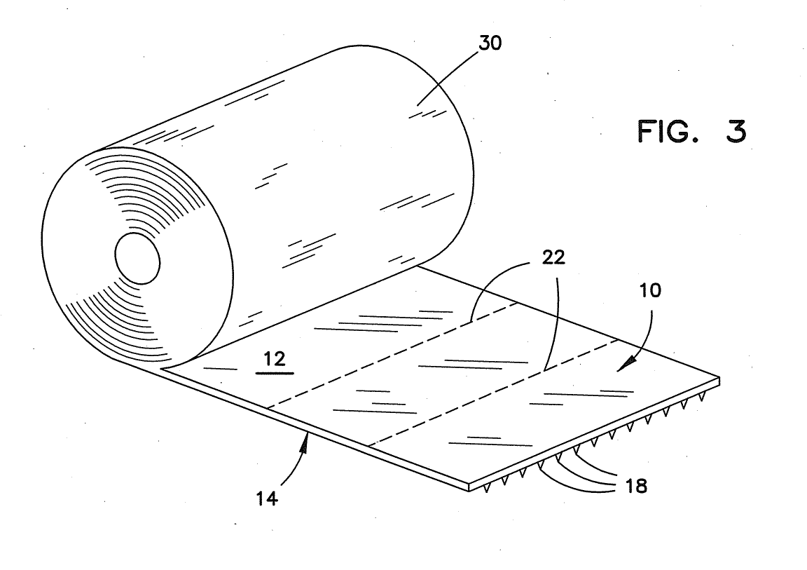

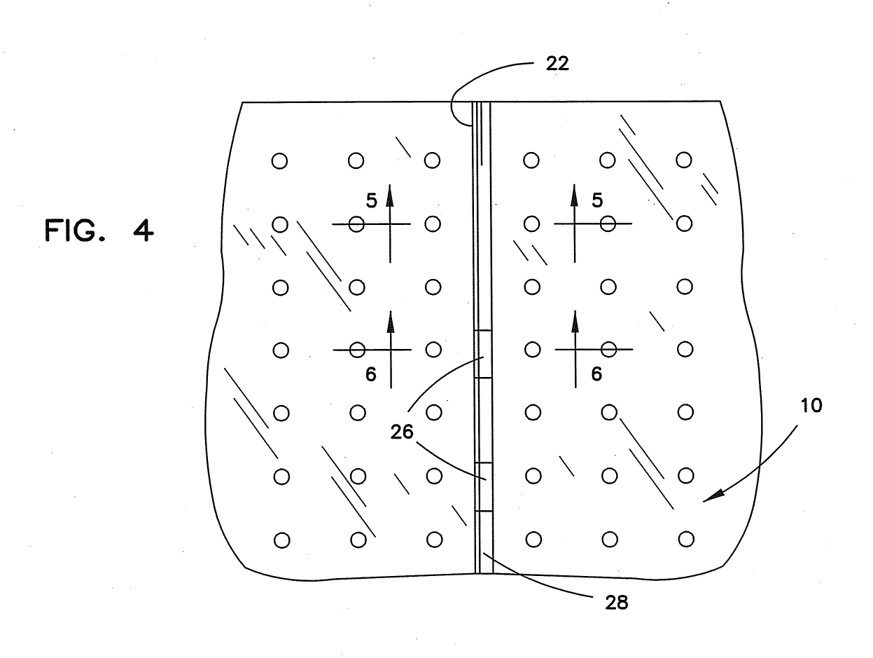

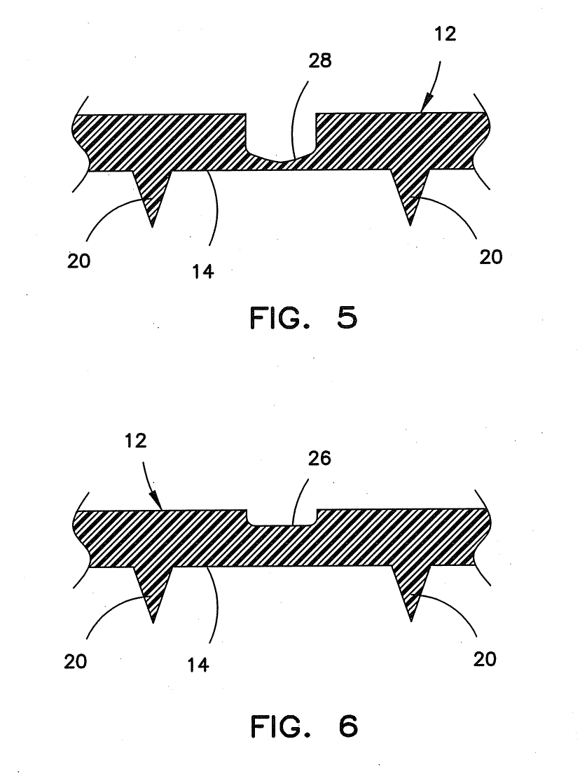

Another carpet runner 10 is shown in FIGS. 3-6 to have a top surface 12 and a lower surface 14. The carpet engaging features 18 can be simple conical projections 20 as best shown in FIGS. 5 and 6. The carpet engaging features 18 can be substantially uniformly distributed across the lower surface 14. The top surface 12 or lower surface 14 can include additional surface features 22. In particular, the surface features 22 can include a series of indentations 26 and 28 designed to permit one to separate a convenient length of the carpet runner 10 from the roll 30 for use in a particular application. The carpet runner 10 can be transparent or sufficiently translucent that the underlying carpet 24 can be seen through the carpet runner 10. The carpet runner 10 shown in FIGS. 3-6 can be used in a printing process, discussed below, which can be applied to the whole or any selected portion of the lower surface 14 of the carpet runner 10.

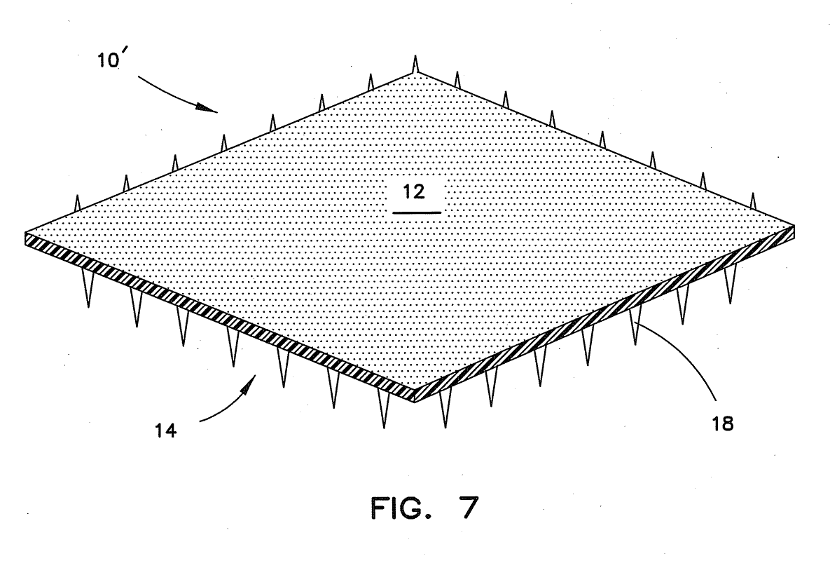

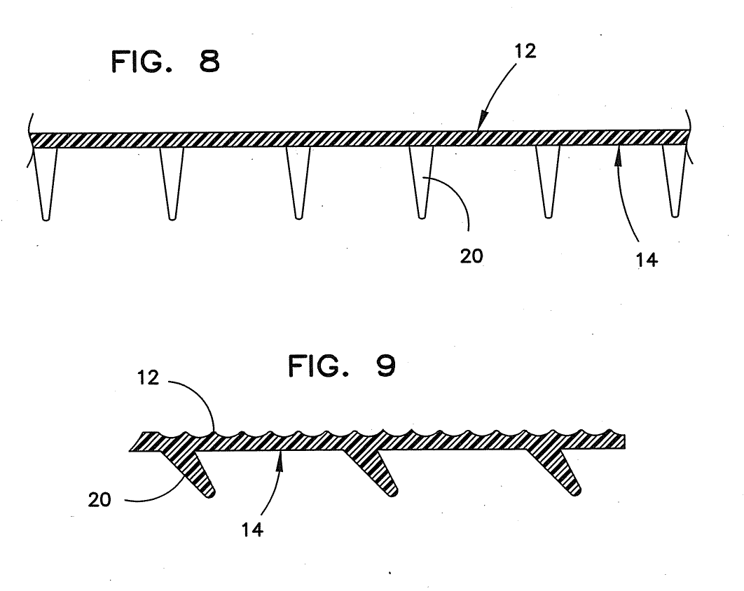

A carpet mat 10′ is shown in FIGS. 7 and 8 having a top surface 12 and a lower surface 14. An array of carpet engaging features 18 can be seen to project downward from the lower surface 14. The carpet engaging features 18 can be simple conical projections 20 which are perpendicular to the lower surface 14 as shown in FIGS. 7 and 8. The carpet engaging features 18 can be substantially uniformly distributed across the lower surface 14. The carpet mat 10′ can be transparent or sufficiently translucent that an underlying carpet can be seen through the carpet mat 10′. The carpet mat 10′ shown in FIGS. 7 and 8 can be used in a printing process, discussed below, which can be applied to the whole or any selected portion of the lower surface 14 of the carpet mat 10′.

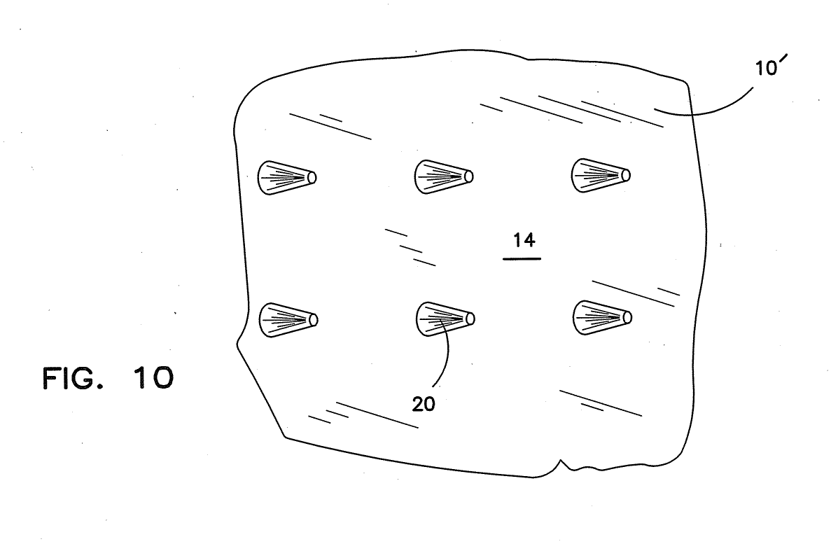

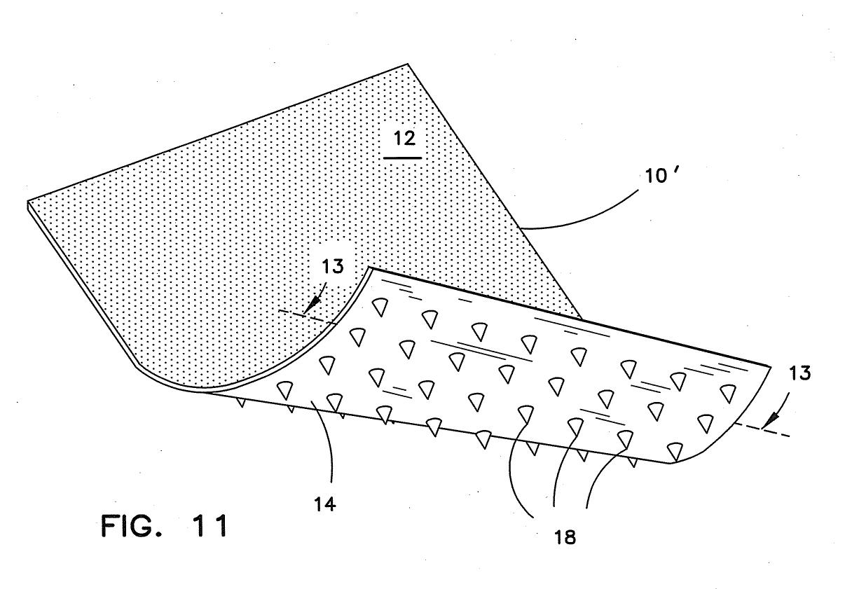

Another carpet mat 10′ is shown in FIGS. 9 and 10 having a top surface 12 and a lower surface 14. An array of carpet engaging features 18 can be seen to project downward from the lower surface 14. The carpet engaging features 18 can be simple conical projections 20 which are inclined with respect to the lower surface 14 as shown in FIGS. 9 and 10. The carpet engaging features 18 can be substantially uniformly distributed across the lower surface 14. The carpet mat 10′ can be transparent or sufficiently translucent that an underlying carpet can be seen through the carpet mat 10′. The carpet mat 10′ shown in FIGS. 9 and 10 can be used in a printing process, discussed below, which can be applied to the whole or any selected portion of the lower surface 14 of the carpet mat 10′.

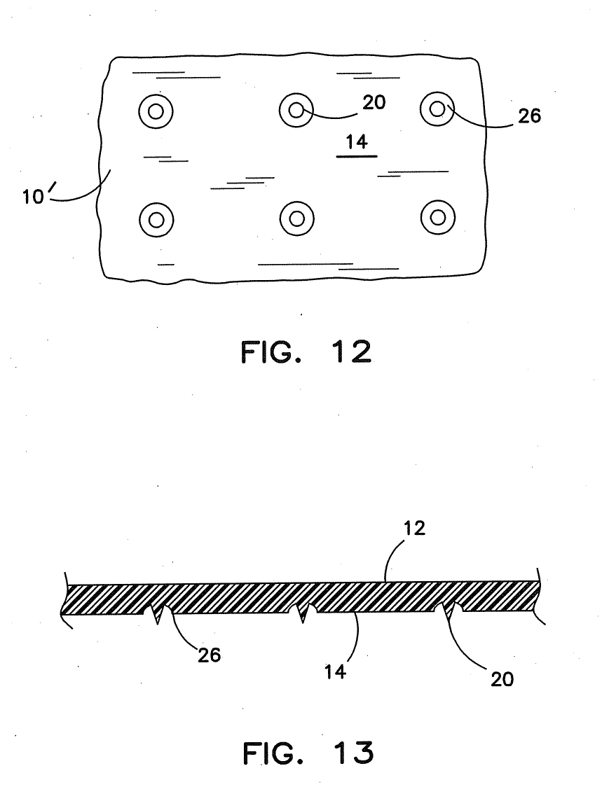

Another carpet mat 10′ is shown in FIGS. 11-13 having a top surface 12 and a lower surface 14. An array of carpet engaging features 18 can be seen to project downward from the lower surface 14. The carpet engaging features 18 can be simple conical projections 20 each of which are surrounded by a recess 26 into the lower surface 14 as best shown in FIGS. 12 and 13. The carpet engaging features 18 can be substantially uniformly distributed across the lower surface 14. The carpet mat 10′ can be transparent or sufficiently translucent that an underlying carpet can be seen through the carpet mat 10′. The carpet mat 10′ shown in FIGS. 11-13 can be used in a printing process, discussed below, which can be applied to the whole or any selected portion of the lower surface 14 of the carpet mat 10′.

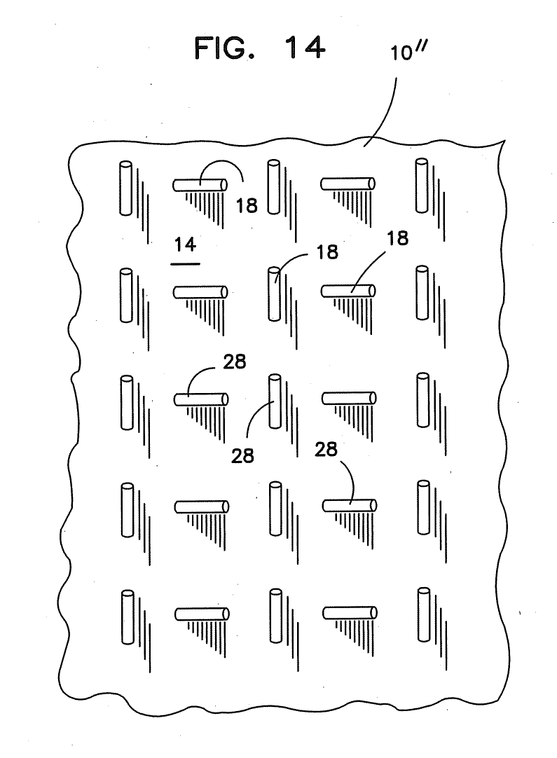

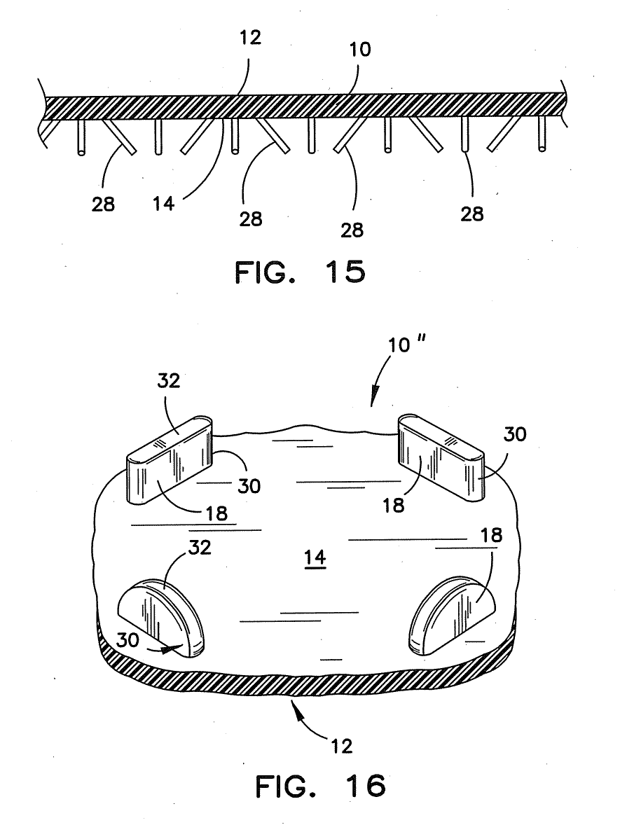

A chair mat 10″ is shown in FIGS. 14 and 15 having a top surface 12 and a lower surface 14. An array of carpet engaging features 18 can be seen to project downward from the lower surface 14. The carpet engaging features 18 can be substantial linear projections 28 which are inclined in a plurality of directions in relation to the lower surface 14 as shown in FIGS. 14 and 15. The carpet engaging features 18 can be substantially uniformly distributed across the lower surface 14. The chair mat 10″ can be transparent or sufficiently translucent that an underlying carpet can be seen through the chair mat 10″. The chair mat 10″ shown in FIGS. 14 and 15 can be used in a printing process, discussed below, which can be applied to the whole or any selected portion of the lower surface 14 of the chair mat 10″.

Another chair mat 10″ is shown in FIG. 16 having a top surface 12 and a lower surface 14. An array of carpet engaging features 18 can be seen to project downward from the lower surface 14. The carpet engaging features 18 can be downwardly projecting cleats 30 having blunt ends 32 which can be elongated along the lower surface 14 as shown in FIG. 16. The carpet engaging features 18 can be substantially uniformly distributed across the lower surface 14 but need not be of uniform character. The chair mat 10″ can be transparent or sufficiently translucent that an underlying carpet can be seen through the chair mat 10″. The chair mat 10″ shown in FIG. 16 can be used in a printing process, discussed below, which can be applied to the whole or any selected portion of the lower surface 14 of the chair mat 10″.

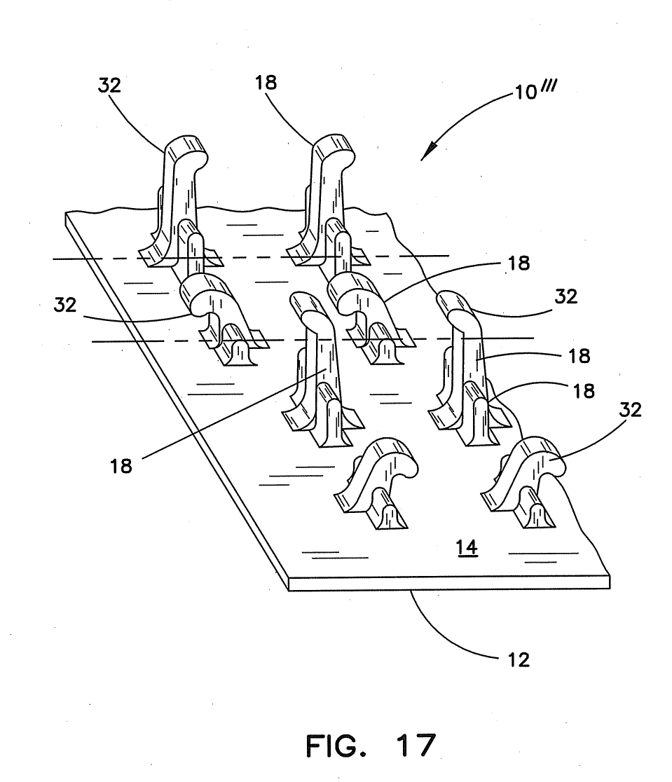

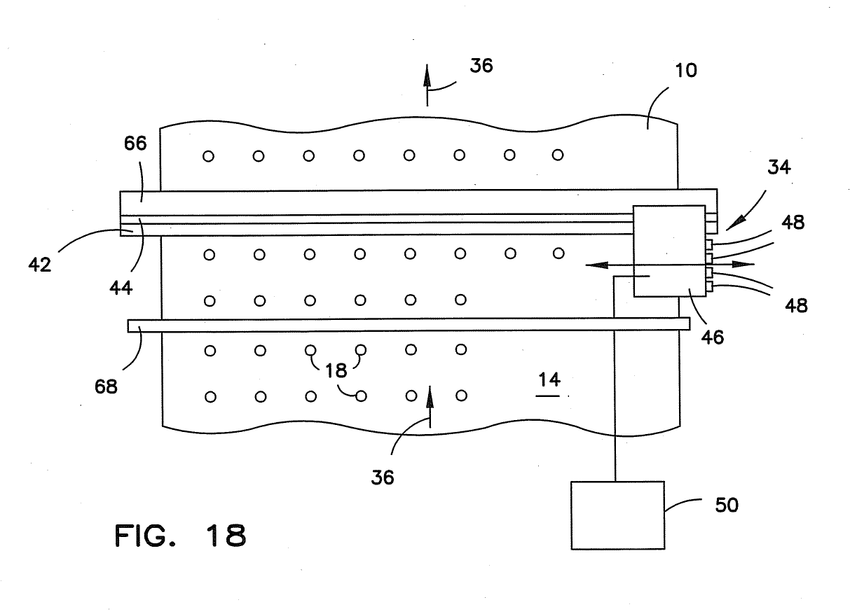

Another carpet mat 10′″ is shown in FIG. 17 having a top surface 12 and a lower surface 14. An array of carpet engaging features 18 can be seen to project downward from the lower surface 14. The carpet engaging features 18 can be complex hook-like projections 32 which can have a variety of orientations with respect to the lower surface 14 as shown in FIG. 17. The carpet engaging features 18 can be substantially uniformly distributed across the lower surface 14. The carpet mat 10′″ can be transparent or sufficiently translucent that an underlying carpet can be seen through the carpet mat 10′″. The carpet mat 10′″ shown in FIG. 17 can be used in a printing process, discussed below, which can be applied to the whole or any selected portion of the lower surface 14 of the carpet mat 10′″.

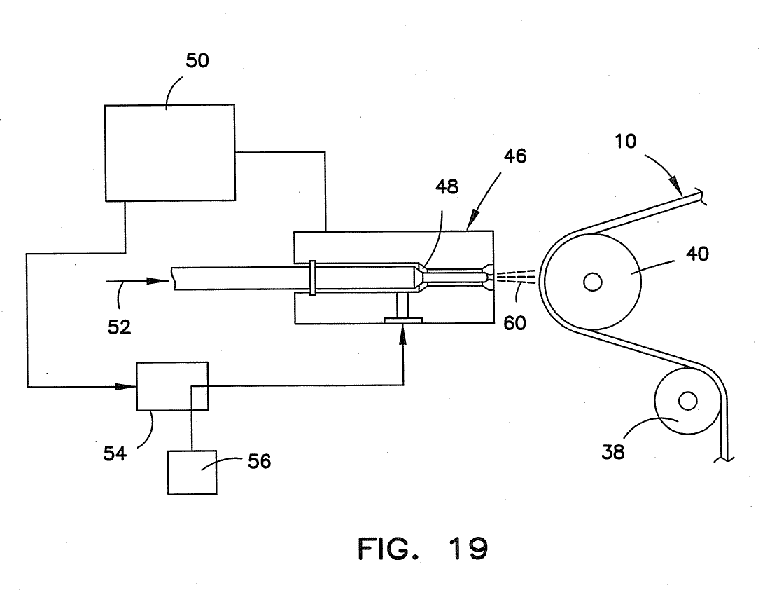

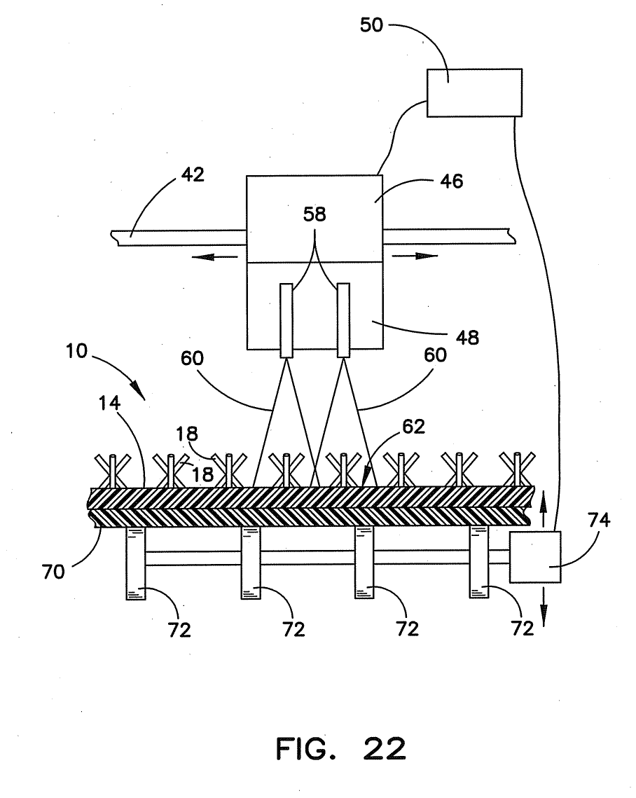

A computer controlled ink jet machine 34 schematically shown in FIGS. 18-21 can be used to apply a desired graphic pattern to the whole or any selected portion of the lower surface 14 of a carpet runner 10, carpet mat 10′, 10′″, or chair mat 10″, hereinafter referred to generally as mat 10, even where the portion to which the graphic pattern is to be applied includes an array of carpet engaging features 18. A suitable machine usable to apply a desired graphic pattern is VUTEK® QS3200r printer available from Vutek, Inc., Meredith, N.H. The ink jet machine 34 can include a drive mechanism for transporting the mat 10 in the direction of the arrows 36 as shown in FIG. 18. The drive mechanism can include a plurality of rollers 38, 40 as schematically shown in FIG. 19. Roller 40 is desirably of very large radius so that the material forming the mat 10 is nearly planar at the point of closest approach to the printing mechanism described below. Alternatively, the mat 10 can be positioned on a planar translation table for transport relative to the printing mechanism as schematically shown in FIG. 22, described below, particularly when thicker or less flexible materials are used to form the mat 10.

The transport of the mat 10 causes it to pass by a guide 42 that is arranged laterally to the direction of transport of the mat 10. The guide 42 can provide a controlled path 44 for the lateral movement of a carriage 46 carrying a plurality of ink jets 48, which can provide for a plurality of colors. An electronic control system 50 can coordinate the movement of the carriage 46 relative to the mat 10. The electronic control system 50 can also coordinate the delivery of ink from each of the ink jets 48 as schematically shown in FIG. 19. Ink can be supplied to each of the ink jets 48 from an ink supply source 52. Ejection of the ink for the ink jet can be controlled by a modulator 54 that controls a flow of current, heat and/or air from another supply source 56.

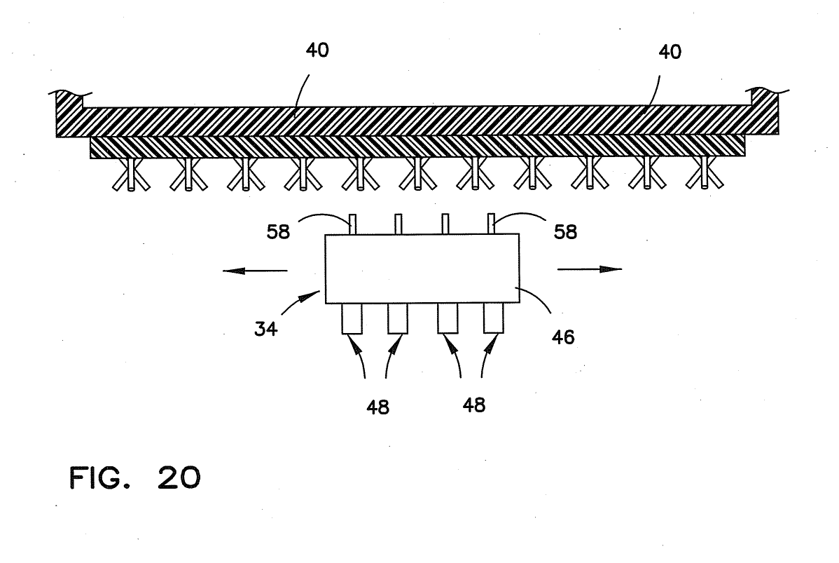

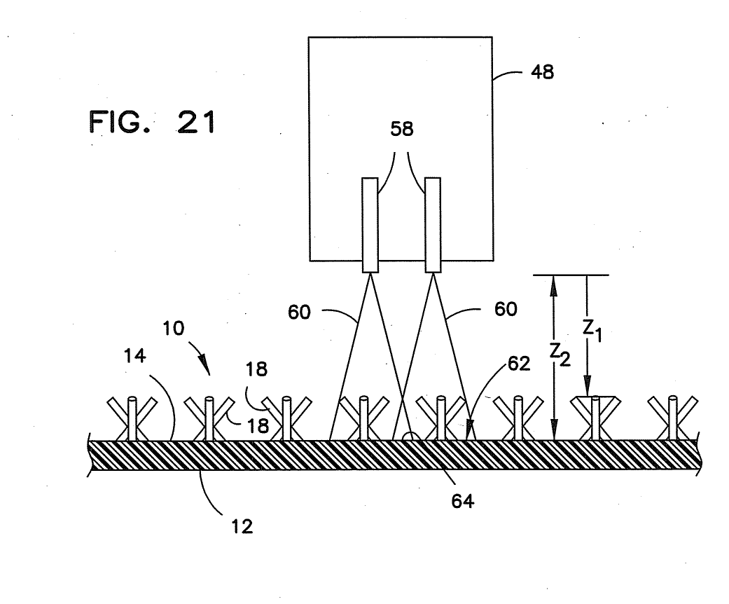

The carriage 46 is shown in FIG. 20 to carry a plurality of ink jets 48. The ejection of ink for each ink jet 48 can be separately controlled as outlined previously as the carriage 46 moves laterally relative to the lower surface 14 of the transported mat 10. It is to be noted that the ink jets 48 are spaced from the lower surface 14 by a distance that is greater than the height of the carpet engaging features 18. This spacing is detailed further in FIG. 21 which shows a single ink jet 48 having a plurality of spray heads 58 arranged in an array. The distance Z₁ from the spray heads 58 to the closest portion of the carpet engaging features 18 is preferably at least 0.060 inches (1.5 mm). The distance Z₂ from the spray heads 58 to the lower surface 14 can be 0.250 inches (6.25 mm) while still maintaining photographic resolution images. Many graphic pattern do not require such resolution so the distance Z₂ can be increased up to about 0.50 inches (12.5 mm). The number of spray heads 58 on each ink jet 48 can range from 2 to 8, or even more. The spray heads 58 can be commonly controlled so that ink is ejected from all of the spray heads 58 on a given ink jet 48. The ink is ejected from each spray head as a cone 60.

The ink ejected from the plurality of spray heads 58 on a given ink jet due to a single pulse from modulator 54 can cover an area 62 on the lower surface 14 of the mat 10 commonly referred to as a pixel. The ink is ejected from the spray heads 58 as a spray of droplets that can be about 10-25 pico-liters in volume. By providing sufficient spacing between the ink jet 48 and the lower surface 14, ink is ejected from the plurality of spray heads 58 onto an overlapping area 64. The size of the overlapping area 64 can be controlled by the spacing between the ink jet 48 and the lower surface 14. The mat lower surface 14 can also be printed with an opaque background, for example white, which is applied after the application of a desired image, by one of the spray heads 58 simultaneously with the generation of the desired image by others of the spray heads 58 on the same or an adjacent ink jet 48. The opaque background is thusly aligned with the desired graphic pattern to enhance the color and contrast of the image.

Moreover, the expanding cone 60 of ink ejected from each spray head 58 has the ability to provide ink to lateral surfaces of the carpet engaging features 18 of the mat 10. The expanding cone 60 of ink ejected from each spray head 58 also has the ability to provide ink to portions of the lower surface 14 that would be shadowed were the ink merely delivered in a single straight line direction rather than the cone 60. As a result ink of any given color can be applied to the whole of a selected area of the lower surface 14 including areas having carpet engaging features 18. The ink is preferably reactive to radiation such as ultra-violet light to bond the ink to the mat lower surface 14 and carpet-engaging features 18. The ultra-violet light can be applied by an irradiation source 66, which can be positioned adjacent the guide 42. At least the selected area of the mat lower surface can be pre-treated by plasma or another oxidizing medium to enhance the acceptance of the ink jet spray. The oxidizing medium dispenser 68 can be positioned adjacent the guide 42 as shown in FIG. 18.

The mat 10 can be positioned on a planar translation table 70 for transport relative to the printing mechanism as schematically shown in FIG. 22. A plurality of rollers 72 can support the translation table 70. At least one of the rollers 72 can be driven by a drive mechanism 74 to transport the mat 10 perpendicular to the guide 42. The guide 42 can provide a controlled path 44 for the lateral movement of a carriage 46 carrying a plurality of ink jets 48, which can provide for a plurality of colors. An electronic control system 50 can coordinate the movement of the carriage 46 and the drive mechanism 74 to position the ink jets 48 at any desired position relative to the mat 10. The electronic control system 50 can also coordinate the delivery of ink from each of the ink jets 48 as schematically shown previously in FIG. 19. The distance between the drive mechanism 74 and the guide 42 can be varied to adjust the spacing between the mat 10 and the spray heads 58 so that the image being printed on the lower surface 14 of the mat 10 will retain the desired image resolution and detail.

While these features have been disclosed in connection with the illustrated preferred embodiments, other embodiments of the invention will be apparent to those skilled in the art that come within the spirit of the invention as defined in the following claims.

What is claimed is:

1. A method of forming a graphics pattern on the lower surface of a mat, the lower surface having carpet engaging features of known maximum height in the area to be supplied with the graphics pattern, the method comprising the steps of:
providing an ink jet having a plurality of spray heads supplied by at least one source of ink, each spray head to deliver a conical spray of ink,
spacing the ink jet from said mat lower surface by a distance exceeding the maximum height of the carpet engaging features,
transporting the ink jet laterally in relation to the mat lower surface, and
supplying the ink jet with a signal modulated by a control to cause ink to be ejected from the ink jet.

2. The method of claim 1, wherein the ink jet is supplied by at least two sources of ink, one of the sources providing a white back layer to enhance the appearance of the graphics pattern being formed.

3. The method of claim 1, further comprising exposing the ink deposited on the lower surface of the mat to radiation selected to bond the ink to the mat lower surface and the carpet-engaging features.

4. The method of claim 3, wherein the radiation is ultra-violet light.

5. The method of claim 1, wherein the spacing of the ink jet from said mat is at a distance of at least 1.5 mm greater than the maximum height of the carpet engaging features.

6. The method of claim 5, wherein the spacing of the ink jet from said mat is at a distance not greater than 12.5 mm from the mat lower surface.

7. The method of claim 1, further comprising pre-treating the mat lower surface with a plasma or other oxidizing medium to enhance the acceptance of the ink jet spray.

8. A method of forming a graphics pattern on the lower surface of a mat, the lower surface having carpet engaging features of known maximum height and having lateral surfaces in the area to be supplied with the graphics pattern, the method comprising the steps of:
providing an ink jet having a plurality of spray heads supplied by at least one source of ink, each spray head to deliver a conical spray of ink,
spacing the ink jet from said mat lower surface by a distance exceeding the maximum height of the carpet engaging features,
transporting the ink jet laterally in relation to the mat lower surface, and
supplying the ink jet with a signal modulated by a control to cause ink to be ejected from the ink jet so that at least part of the conical spray of ink contacts some of the lateral surfaces of the carpet engaging features, and
bonding the ink to the mat and carpet engaging features.

9. The method of claim 8, wherein the spacing of the ink jet from said mat is at a distance not greater than 12.5 mm from the mat lower surface.

10. The method of claim 9, wherein the spacing of the ink jet from said mat is at a distance of at least 1.5 mm greater than the maximum height of the carpet engaging features.

11. The method of claim 10, wherein the ink jet is supplied by at least two sources of ink, one of the sources providing a white back layer to enhance the appearance of the graphics pattern being formed.

12. The method of claim 11, wherein the bonding step is achieved by exposing the ink deposited on the lower surface of the mat to radiation selected to bond the ink to the mat lower surface and the carpet-engaging features.

13. The method of claim 12, wherein the radiation is ultra-violet light.

14. The method of claim 11, wherein the bonding step is further achieved by pre-treating the mat lower surface with a plasma or other oxidizing medium to enhance the acceptance of the ink jet spray.

15. A mat having an upper surface and a lower surface, the lower surface having carpet engaging features of known maximum height having lateral surfaces, the lower surface also having a graphics pattern bonded to the lower surface of a mat by a process comprising the steps of:
providing an ink jet having a plurality of spray heads supplied by at least one source of ink, each spray head to deliver a conical spray of ink,
spacing the ink jet from said mat lower surface by a distance exceeding the maximum height of the carpet engaging features,
transporting the ink jet laterally in relation to the mat lower surface, and
supplying the ink jet with a signal modulated by a control to cause ink to be ejected from the ink jet so that at least part of the conical spray of ink contacts some of the lateral surfaces of the carpet engaging features, and
bonding the ink to the mat and carpet engaging features.

16. A mat produced by the process of claim 15, wherein the spacing of the ink jet from said mat is at a distance not greater than 12.5 mm from the mat lower surface.

17. A mat produced by the process of claim 15, wherein the spacing of the ink jet from said mat is at a distance of at least 1.5 mm greater than the maximum height of the carpet engaging features.

18. A mat produced by the process of claim 15, wherein the ink jet is supplied by at least two sources of ink, one of the sources providing a white back layer to enhance the appearance of the graphics pattern formed.

19. A mat produced by the process of claim 15, wherein the bonding step is achieved by exposing the ink deposited on the lower surface of the mat to radiation selected to bond the ink to the mat lower surface and the carpet-engaging features.

20. A mat produced by the process of claim 19, wherein the radiation is ultra-violet light.
